(19) United States
(12) Patent Application Publication
(10) Pub. No.: US 2007/0261899 A1
(43) Pub. Date: Nov. 15, 2007

(54) Subscription-based pre-provisioned towable unit facilitation method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/423,594

(22) Filed: Jun. 12, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/381,677, filed on May 4, 2006.
Application No. 11/381,677 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.

(51) Int. Cl. A01B 71/06; B62D 53/00; B62D 59/04

(52) U.S. Cl. 180/14.1

(57) ABSTRACT

One provides (101, 102) at least one towable rolling terrestrial container and emergency survival items. The emergency survival items are positioned (103) in the towable rolling terrestrial container(s) to provide at least one corresponding pre-provisioned towable unit. Consideration-based private civil security subscriptions are then accepted (107) from one or more subscribers with respect to providing civilly-catastrophic event-based access to the pre-provisioned towable unit. The pre-provisioned towable unit is then maintained (108) pending a need to permit subscription-based access to the pre-provisioned towable unit upon occurrence of a catastrophic event. If desired, other items, such as selected non-necessities of life, can be included (103) with the emergency survival items. The pre-provisioned towable units can be stored at a shared location and attended, if desired, by dedicated attendants (105). Such attendants can provide security services, for example, and/or can assist with maintaining the towable rolling terrestrial containers and/or their contents.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

POSITIVE PRESSURE FILTRATION KIT APPARATUS AND METHOD, as filed on May 4, 2006 and having application Ser. No. 11/381,677;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD; as filed on Jun. 1, 2006 and having application Ser. No. 11/421,694; the contents of which are fully incorporated herein by this reference.

### TECHNICAL FIELD

This invention relates generally to providing emergency provisions.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or human-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the subscription-based pre-provisioned towable unit facilitation method described in the following detailed description, particularly when studied in conjunction with the drawings, wherein:

FIG. 1 comprises a flow diagram as configured in accordance with various embodiments of the invention;

FIG. 2 comprises a block diagram view as configured in accordance with various embodiments of the invention; and

FIG. 3 comprises a block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides at least one towable rolling terrestrial container and emergency survival items. The emergency survival items are positioned in the towable rolling terrestrial container(s) to provide at least one corresponding pre-provisioned towable unit. Consideration-based private civil security subscriptions are then accepted from one or more subscribers with respect to providing civilly-catastrophic event-based access to the pre-provisioned towable unit. The pre-provisioned towable unit is then maintained pending a need to permit subscription-based access to the pre-provisioned towable unit upon occurrence of a catastrophic event.

If desired, other items, such as selected non-necessities of life, can be included with the emergency survival items. The pre-provisioned towable units can be stored at a shared location and attended, if desired, by dedicated attendants. Such attendants can provide security services, for example, and/or can assist with maintaining the towable rolling terrestrial containers and/or their contents.

So configured, authorized beneficiaries of such consideration-based private civil security subscriptions will have concrete, predictable access to a pre-provisioned towable unit upon the occurrence of a catastrophic event. Such persons can then move the pre-provisioned towable unit to a location of their choosing to thereby better facilitate their own ability to survive the catastrophic event. The type and quantity of emergency survival items can be selected (and their maintenance governed) by experts and hence relieve the authorized beneficiary of responsibility in this regard.

These steps are facilitated without dependency upon governmental oversight, participation, or control. The particular supplies (and/or the quantity of supplies) provided can vary with the needs and requirements of the authorized beneficiaries. Importantly, via these teachings an individual can take important steps to bring a considerably improved measure of security into their lives, knowing that, should a civilly-catastrophic event indeed be visited upon them, they will have extraordinary and reliable access to survival supplies.

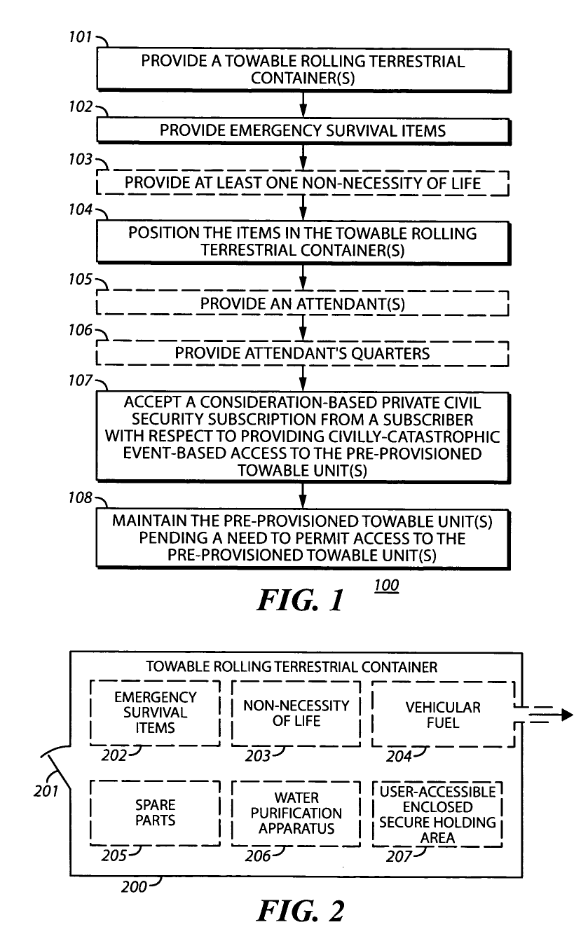

These and other benefits may become clearer upon making a thorough review and study of the following detailed description. Referring now to FIG. 1, an illustrative process 100 provides for provision 101 of one or more towable rolling terrestrial containers. This may comprise providing, for example, a trailer of essentially any size and configuration including, but not limited to, a fully covered trailer, an open-top trailer, an open-side trailer, and so forth. In general, it will probably be preferred that the trailer comprise a fully enclosed unit having a floor, walls, and roof. (Those skilled in the art will recognize that almost any rolling platform is technically capable of being towed. As used herein, “towable” refers to a platform that is configured and arranged with towability comprising a primary use case. Therefore, for present purposes, a rolling platform such as an automobile is not considered “towable” notwithstanding that, technically, such a platform is capable of being towed as a secondary use case.)

In some cases it may be useful to configure and arrange the towable rolling terrestrial containers to be able to traverse off-road conditions. Such a capability may be useful, for example, to successfully move past debris, stalled, blocked, or abandoned vehicles, impassable roadways, and so forth. This can comprise configuring the towable rolling terrestrial containers with a higher-than-normal suspension, a heavy-duty suspension, self-braking capability, and so forth. Such accoutrements are known in the art and require no further elaboration here.

With momentary reference to FIG. 2, this towable rolling terrestrial container 200 can be configured with at least one access door 201. This access door 201 can comprise any door of choice including, but not limited to, a pivoting door, a sliding door, a multi-part door, and so forth. By one approach this access door 201 can have a corresponding locking mechanism. Any suitable locking mechanism can be employed in this regard including, but not limited to, key-based locks, combination locks, electronic locks, and so forth. When so configured, an authorized beneficiary (as described below) may, if desired, be the only party having the ability to unlock the locking mechanism. More typically, however, it may be preferred to permit other authorized personnel to also have such access in order to facilitate, for example, maintenance of the towable rolling terrestrial container and its contents.

By one approach this towable rolling terrestrial container has a tongue to permit conveniently and effectively coupling the towable rolling terrestrial container to a towing vehicle hitch of choice. Various choices in this regard are well known in the art and other options are likely to be developed in the future. As the present teachings are relatively insensitive to the selection of any particular choice in this regard, for the sake of brevity and clarity further elaboration regarding such tongues will not be provided here.

Referring again to FIG. 1, this process 100 also provides for provision 102 of emergency survival items. This can comprise, for example, providing a plurality of life-sustaining resources as pertain to a plurality of differing categories of life's necessities (such as, but not limited to, hydration, nourishment, shelter, environmentally borne threat abatement, and so forth). Such emergency survival items can comprise consumable items (including consumable necessities of human life), non-consumable items (including non-consumable necessities of human life), or both. Illustrative examples of consumable items would include, but are not limited to:

food supplies;

potable water;

batteries;

personal hygiene supplies; and

medical supplies;

to note but a few. Illustrative examples of non-consumable items could include, but are not limited to:

essential clothing items;

personal protection items (such as face masks, gloves, foul-weather gear, and so forth);

bedding items;

food preparation items;

power generation equipment;

repair and maintenance tools;

navigation equipment;

communication items; and

shelter items (such as, for example, a tent);

to again note but a few.

This process 100 will also optionally accommodate providing 103 at least one non-necessity of life. Illustrative examples in this regard might include, but are not limited to:

luxury consumable items;

luxury non-consumable items;

non-essential clothing;

non-human nourishment (such as pet food);

barter medium (including, for example, precious metals in a convenient barterable form);

entertainment apparatus;

educational tools;

physical conditioning, exercise, and maintenance training and equipment;

crafts supplies and training; and

sports equipment and facilities;

to note but a few.

This process 100 then provides for positioning 104 the emergency survival items (and the non-necessities if so provided) in the towable rolling terrestrial container (or containers) to thereby provide a pre-provisioned towable unit(s). As illustrated in FIG. 2, this can comprise placing the emergency survival items 202 (and the selected non-necessities of life 203, if any) inside the towable rolling terrestrial container 200. Such placement can be accomplished in any of a variety of ways. By one approach, these items can simply be loosely placed inside the towable rolling terrestrial container 200. By another approach the items can be bundled together (using, for example, boxes or other secondary containers, shrink wrap material, straps, tarps, tie-downs, or the like) and then placed inside the towable rolling terrestrial container 200. When taking this approach, if desired, the resultant bundle can itself be placed on a pallet to facilitate loading and unloading the bundle with respect to the towable rolling terrestrial container 200.

Other approaches are also possible. For example, if desired, the interior of the towable rolling terrestrial container 200 can be configured with shelves, hooks, pockets, drawers, and other storage accoutrements to facilitate the positioning of such items. By one approach, items that are intended for longer-term survival needs can be packed deeper within the interior of the towable rolling terrestrial container while items intended for shorter-term or more immediate survival needs can be positioned closer to the access door 201. So configured, items that are more likely to be needed earlier than other items are placed to avoid having to remove an undue number of presently-unneeded items in order to access the presently-needed items.

If desired, the towable rolling terrestrial container 200 can further comprise a vehicular fuel storage tank 204. In such a case, the provided emergency survival items can comprise, at least in part, vehicular fuel (such as, for example, gasoline, diesel fuel, and so forth) that is then pre-positioned in the vehicular fuel storage tank 204. By one approach, this vehicular fuel storage tank 204 can further comprise a fuel pump such that vehicular fuel stored in the vehicular fuel storage tank 204 can be readily transferred to a towing vehicle to thereby extend the travel distance capability of the towing vehicle. This may comprise an important asset and capability in at least some application settings when the challenges facing a user of this towable rolling terrestrial container include a shortage or unavailability of vehicular fuel.

Also if desired, the towable rolling terrestrial container 200 can optionally further be provisioned to carry one or more spare parts 205 of choice. These can comprise spare parts particularly intended for the towable rolling terrestrial container itself and/or a towing vehicle for the towable rolling terrestrial container. Such spare parts might comprise, for example, one or more spare tires, spare fuses, spare illumination sources (such as light bulbs), and spare mechanical parts of various types. Such spare parts 205, when provided, can be stored within the towable rolling terrestrial container 200 or can be provided, in whole or in part, in a storage container that is at least partially accessible from the exterior of the towable rolling terrestrial container.

By one approach, the towable rolling terrestrial container 200 can optionally further comprise water purification apparatus 206. Such water purification apparatus 206 would then be available for use in a time of emergency to cleanse water and render it potable. Various such apparatus are known in the art and require no further explanation here. If desired, the towable rolling terrestrial container 200 can also optionally comprise one or more user-accessible enclosed secure holding areas 207 formed, for example, in a wall of the towable rolling terrestrial container 200 (wherein the term “wall” will be understood to refer to any horizontal partition such as a vertical wall, a roof, a floor, and so forth). This can comprise, for example, a user-lockable enclosed secure holding area (such as a key-locked or combination lock-protected safe or the like) and/or a camouflaged user-accessible enclosed secure holding area that is not readily discernable to ordinary observation (where, for example, the door to the enclosed secure holding area is hidden behind other built-in structures or itself blends in with other proximal structures and design elements).

By one approach, the towable rolling terrestrial container 200 can comprise a substantially air-tight container. This can be helpful, for example, to prevent airborne contaminants from entering the towable rolling terrestrial container 200. If desired, the towable rolling terrestrial container 200 can optionally be configured to further include an air mover/filter system to thereby permit exterior filtered air to be drawn into the interior of the towable rolling terrestrial container 200 to thereby selectively create positive air pressure relative to external ambient conditions. Positive air pressure will, in turn, aid with respect to urging external air borne contaminants away from such openings as may exist in the towable rolling terrestrial container 200. When so configured, those skilled in the art will recognize that the towable rolling terrestrial container 200, when at least partially emptied of its contents (or when space is otherwise provided even when fully stocked) can also serve as at least a temporary shelter for one or more persons and will at least aid in protecting such persons from dangerous air-borne contaminents.

In some cases, one or more of the items pre-positioned in the towable rolling terrestrial container 200 may require, or benefit from, refrigeration. If desired, a refrigerated storage container can be provided in the towable rolling terrestrial container 200 to retain such items in a refrigerated state during storage. In a typical embodiment in this regard the refrigerated storage container will comprise, at least in part, a thermally insulated storage container.

By one approach, this refrigerated storage container can be electrically powered. So configured, external power can be applied via an appropriate electrical connection during storage. When deploying the towable rolling terrestrial container 200 during an emergency, this coupling would be disconnected. In such a case, the refrigerated items would remain cool for some near-term period of time as a function, at least in part, of the effectiveness of the thermal insulation of the container itself.

By another approach the towable rolling terrestrial container 200 can be configured to include an electrical power source (such as a generator, an inverter/battery system, and so forth). In such a case, electrically powered refrigeration could continue even during deployment of the towable rolling terrestrial container in an emergency (so long as the power source remained viable).

By yet another approach, in combination with or in lieu of the approach just mentioned, the refrigerated storage container can comprise a dual-mode device that is capable of operating, for example, using propane (or a tri-mode device that is capable of automatically selecting from amongst alternating current when available, direct current when available, and propane). These and other approaches to providing refrigeration are known in the art and hence require no further detailed description here.

If desired, the towable rolling terrestrial container 200 can be configured and arranged to serve as more than a storage and transport facility for the items mentioned. For example, by one approach, the towable rolling terrestrial container 200 can be configured and arranged to also serve, if desired, as living quarters for one or more individuals. This can comprise, for example, providing one or more of sleeping accommodations, food preparation facilities, personal hygiene facilities, and/or sitting accommodations (either internal to or external to the towable rolling terrestrial container 200). By one approach, such living quarters can be at least partially disposed on the interior of the towable rolling terrestrial container 200 with at least some of the emergency survival items then pre-positioned in those living quarters. It may also be useful, at least in anticipation of some application settings, to provide the towable rolling terrestrial container with at least one retractable exterior-mounted awning as is known in the art.

By one approach, the towable rolling terrestrial container can also optionally be configured with communications facilities. This can comprise, as desired, one-way and two-way communications facilities. By one approach, if desired, the towable rolling terrestrial container can be configured with a radio frequency antenna mast. This can comprise a fixed-position mast or can comprise a retractable and/or otherwise extendable or movable mast that can be placed in position when needed. So configured, a wireless communications device of choice (such as, for example, a cellular telephone) can be operably coupled thereto to thereby extend the corresponding effective communications range of the device. This can further comprise, if desired, use of signal amplifiers to increase reception and/or transmission capabilities.

Referring again to FIG. 1, if desired, this process 100 will further optionally accommodate providing 105 one or more attendants. This attendant (or attendants) may comprise, for example, a substantially full-time attendant. By one approach, these attendants are provided on-site at a predetermined location that contains the pre-provisioned towable units. In this regard, for example, this process 100 can then further provide for provision 106 of attendant's quarters at, or proximal to, that predetermined location.

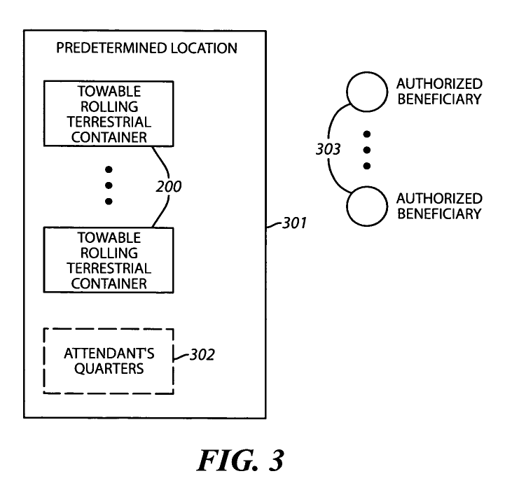

To illustrate, and referring momentarily to FIG. 3, such an optional attendant's quarters 302 can be located on-site at a predetermined location 301 of choice that also accommodates, in this example, a plurality of towable rolling terrestrial containers 200 that are pre-provisioned as described herein. By one approach this predetermined location 301 will comprise a relatively secure facility to prevent unauthorized access to the pre-provisioned towable units prior to, or during, an emergency scenario. In this regard, one or more of the aforementioned attendants can be employed to monitor, enhance, or enforce such security. In a perhaps typical deployment scenario, this predetermined location 301 will perhaps be relatively proximal to the intended service audience of authorized beneficiaries 303 as are described below. Such proximity may be preferred by such beneficiaries 303 to better ensure their ability to access these corresponding assets during a time of need.

This process 100 then provides for accepting 107 consideration-based private civil security subscriptions from corresponding subscribers with respect to providing civilly-catastrophic event-based access to the pre-provisioned towable unit. This right of access can pertain, if desired, to a predetermined period of time. For example, a given subscription can relate to providing access to the towable rolling terrestrial vehicle for a one year period of time for one or more authorized beneficiaries as correspond to that subscription.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights with respect to the towable rolling terrestrial container, its contents, or both);

non-transferable rights of access (as may occur when the subscription, by its terms and conditions, prohibits transfer of the right of access to the towable rolling terrestrial container, its contents, or both from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the towable rolling terrestrial container, its contents, or both); and/or

non-ownership-based rights of access (as may occur when the subscription, by its terms and conditions, establishes the aforementioned right of access via, for example, a lease, rental, or borrowing construct).

If desired, a plurality of differentiated subscription opportunities can be offered in this regard. This plurality of differentiated subscription opportunities can correspond, for example, to providing access to differing towable rolling terrestrial containers, contents, or both. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for a relatively large towable rolling terrestrial container that contains a relatively large store of supplies while another less expensive subscription can provide for a relatively smaller towable rolling terrestrial container than contains a relatively smaller store of supplies. As another example, different subscriptions can be provided that reflect different combinations and quantities of the items that are pre-positioned within the towable rolling terrestrial containers. Other possibilities are of course possible.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to one or more pre-provisioned towable units in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice. In addition, or in lieu thereof, such access may be predicated, if desired, upon a requirement of a particular level of objectively or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure and ability to provide in ordinary course for the at least one life-sustaining resource that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as intentional acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

It would also be possible to supplement such access by permitting access to the pre-provisioned towable unit upon the occurrence of some other event or circumstance that might present the authorized beneficiary with a serious challenge while not itself necessarily rising to the level of a civilly-catastrophic event. For example, if desired, access to the subscribed-to assets might be permitted when an authorized beneficiary's home is destroyed by fire.

This process 100 also provides for maintaining 108 the pre-provisioned towable unit pending a need to permit subscription-based access to the pre-provisioned towable unit upon occurrence of a catastrophic event. Such maintenance can comprise, for example, maintaining both operational serviceability of the towable rolling terrestrial container as well as the utility of the emergency survival items as are pre-positioned therein.

Such maintenance can also optionally comprise making adjustments to such supplies to reflect dynamically changing circumstances as occur during the consideration-based private civil security subscription period. As one illustration, a new item may become available that is particularly useful in dealing with or otherwise surmounting some condition that may likely arise upon the occurrence of a particular kind of civilly-catastrophic event. In such a case, maintaining such supplies can readily accommodate updating the acquired and stored items to include a supply of this new item.

Accordingly, such maintenance can readily comprise one or more of removing a particular one of the stored items (as when a better substitute becomes available, when the item itself is shown to be less effective for its intended purpose than was originally thought, and so forth), adding additional ones of a particular item (as when it becomes subsequently understood that more of a particular item is desirable to achieve a particular goal or purpose), adding at least one new stored item that is not already stored (as illustrated in the example provided above), and so forth.

Such maintenance can also comprise, if desired, storing the pre-provisioned towable unit in a covered shelter at the aforementioned predetermined location for at least a substantial period of time pending a civilly-catastrophic event. This covered shelter can be configured to house a plurality of such pre-provisioned towable units if desired. By one approach the covered shelter may essentially comprise only a roof. By another approach the covered sheltered may also comprise one or more walls as well to further aid in protecting the pre-provisioned towable unit(s) from the elements, unauthorized access, prying eyes, and so forth.

Much is known in the art regarding construction and maintenance of covered shelters (including both above ground and below ground facilities). Such a construction will usually at least serve to protect the towable rolling terrestrial containers and their contents from environmental stress and extremes. In addition to walls and a roof as previously mentioned such a covered shelter may also optionally comprise internal temperature control, lighting, storage facilities, sleeping facilities (for on-site attendants as mentioned above, for example), food preparation facilities, personal hygiene facilities, and so forth.

The aforementioned maintenance can further comprise conducting test drills and/or training with on-site attendants and/or with the authorized beneficiaries of the previously mentioned subscriptions. Such drills can comprise, for examples, drills to practice locating and arriving at the predetermined location, locating and identifying a particular pre-provisioned towable unit, attaching a towing vehicle to the pre-provisioned towable unit, towing the per-provisioned towable unit (including, for example, over a test course that presents various navigational and control challenges), accessing and/or using the pre-provisioned supplies, and performing and/or experiencing other circumstances or events of possible relevance or interest. Such drills may also entail, if desired, simulated and/or replicated conditions that may pose a particular challenge if encountered during a non-drill time of need.

These teachings can also accommodate, if desired, confirming the occurrence of a triggering civilly-catastrophic event and responsively then permitting subscription-based access to the aforementioned resources. This may comprise, if desired, use of a mechanism that the authorized beneficiary carries with them to confirm their authorized status in this regard. This mechanism can comprise personal property (such as an identification card) or can comprise, for example, a biometric-based identity authentication process that relies upon fingerprints, retinal patterns, or some other relatively unique aspect of the human body. By one approach, if desired, the tongue mechanism for the pre-provisioned towable unit can comprise a non-standard mechanism such that ordinarily available towing hitches can not successfully and compatibly tow the pre-provisioned towable unit.

In combination therewith (or in lieu thereof), an electronic transponder can be carried by the towing vehicle that transmits a unique identifying signal. The pre-provisioned towable unit, in turn, can be configured and arranged to prohibit or inhibit successfully hitching and/or moving the pre-provisioned towable unit in the absence of that unique identifying signal. Such a capability would aid in preventing unauthorized movement of the pre-provisioned towable unit.

It will be appreciated that these teachings provide for a highly flexible yet powerfully effective way by which a modern citizen can greatly improve their likelihood of surviving a civilly-catastrophic event. These teachings are sufficiently flexible so as to accommodate the needs and desires of a wide-ranging set of potential beneficiaries while nevertheless still tending to ensure adequate access to the basic necessities of life. Though training and some related activity may be provided and encouraged, in general the beneficiary receives these benefits without being required to make the commitment of time, energy, and expertise that would ordinarily be associated with attaining such a high level of civil security.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, the aforementioned store of supplies can be supplemented by providing additional such supplies in one or more roof-top carriers that are attached to the roof of the towable rolling terrestrial container. As another example, these teachings could be employed with self-powered vehicles (such as class A, B, or C motorhomes). By this approach, the self-powered vehicle would be used in lieu of the aforementioned towable rolling terrestrial container and would be similarly pre-provisioned and maintained in readiness for the benefit of subscription-based authorized beneficiaries. Or, if desired, the aforementioned pre-provisioned towable unit could be pre-hitched to a self-powered vehicle (such as an automobile or motorhome) that is also maintained in readiness in a manner similar to that described above.

As another example in this regard, the interior (and/or exterior) of the towable rolling terrestrial container can be comprised, at least in part, of drawers, cabinets, sliding trays, and so forth that might be at least partially interchangeable with one another. Such a configuration might facilitate organization of the stored items and/or ease, control, or facilitate accessing such supplies during a time of need.

As yet another example in this regard, one or more of the walls of the towable rolling terrestrial container might comprise watertight hollow structures having closeable openings formed therein. So configured, water or other liquids (such as fuels of various kinds) might be stored therein and accessed as needed during a time of need.

I claim:

1. A method comprising:
providing a towable rolling terrestrial container;
providing emergency survival items;
positioning the emergency survival items in the towable rolling terrestrial container to provide a pre-provisioned towable unit;
accepting a consideration-based private civil security subscription from a subscriber with respect to providing civilly-catastrophic event-based access to the pre-provisioned towable unit;
maintaining the pre-provisioned towable unit pending a need to permit subscription-based access to the pre-provisioned towable unit upon occurrence of a catastrophic event; such that an authorized beneficiary of the consideration-based private civil-security subscription will have concrete, predictable access to the pre-provisioned towable unit upon the occurrence of a catastrophic event and will be able to move the pre-provisioned towable unit to a location of choice to thereby better facilitate their own ability to survive the catastrophic event.

2. The method of claim 1 wherein the towable rolling terrestrial container comprises at least one of:
a fully covered trailer;
an open-top trailer;
an open-side trailer.

3. The method of claim 1 wherein providing a towable rolling terrestrial container comprises providing a towable rolling terrestrial container having an access door.

4. The method of claim 3 wherein:
providing a towable rolling terrestrial container having an access door comprises providing a towable rolling terrestrial container having an access door having a locking mechanism;
pre-positioning the emergency survival items in the towable rolling terrestrial container comprises locking the access door after pre-positioning the emergency survival items in the towable rolling terrestrial container.

5. The method of claim 4 wherein locking the access door comprises locking the access door using a locking process that only the authorized beneficiary can unlock.

6. The method of claim 1 wherein maintaining the pre-provisioned towable unit comprises locking the pre-provisioned towable unit in place pending the need to permit subscription-based access to the pre-provisioned towable unit.

7. The method of claim 6 wherein locking the pre-provisioned towable unit in place comprises locking the pre-provisioned towable unit in place using a locking process that only the authorized beneficiary can unlock.

8. The method of claim 1 wherein providing emergency survival items comprises providing a plurality of life-sustaining resources as pertain to a plurality of differing categories of life's necessities.

9. The method of claim 8 wherein the plurality of life-sustaining resources comprise at least one of:
hydration;
nourishment;
shelter;
environmentally borne threat abatement.

10. The method of claim 1 wherein the emergency survival items comprise at least one of:
a consumable necessity of human life;
a non-consumable necessity of human life.

11. The method of claim 1 further comprising:
providing at least one non-necessity of human life;
and wherein pre-positioning the emergency survival items in the towable rolling terrestrial container to provide a pre-provisioned towable unit further comprises pre-positioning the at least one non-necessity of human life in the towable rolling terrestrial container to provide the pre-provisioned towable unit.

12. The method of claim 11 wherein the at least one non-necessity of human life comprises at least one of:
a luxury consumable item;
a luxury non-consumable item;
non-human nourishment;
barter medium;
an entertainment apparatus;
an educational tool;
physical conditioning, exercise, and maintenance training and equipment;
crafts supplies and training;
sports equipment and facilities.

13. The method of claim 1 wherein maintaining the pre-provisioned towable unit comprises at least one of:
maintaining utility of the emergency survival items as are pre-positioned in the towable unit;
making adjustments to the emergency survival items as are pre-positioned in the towable unit to reflect dynamically changing circumstances as occur during the consideration-based private civil security subscription.

14. The method of claim 13 wherein making adjustments to the emergency survival items as are pre-positioned in the towable unit comprises at least one of:
removing a particular one of the emergency survival items;
adding additional ones of the emergency survival items;
adding at least one new emergency survival item that is not already pre-positioned in the towable unit.

15. The method of claim 1 wherein:
providing a towable rolling terrestrial container comprises providing a towable rolling terrestrial container having at least one vehicular fuel storage tank;
providing emergency survival items comprises, at least in part, providing vehicular fuel;
pre-positioning the emergency survival items in the towable rolling terrestrial container to provide a pre-provisioned towable unit comprises pre-positioning the vehicular fuel in the at least one vehicular fuel storage tank.

16. The method of claim 15 wherein providing vehicular fuel comprises providing at least one of gasoline and diesel fuel.

17. The method of claim 15 wherein providing a towable rolling terrestrial container having at least one vehicular fuel storage tank further comprises providing a towable rolling terrestrial container having a fuel pump capability such that vehicular fuel stored in the vehicular fuel storage tank can be readily transferred to a towing vehicle from the towable rolling terrestrial container to thereby extend a travel distance capability of the towing vehicle.

18. The method of claim 1 wherein providing a towable rolling terrestrial container comprises providing a plurality of towable rolling terrestrial containers.

19. The method of claim 18 wherein pre-positioning the emergency survival items in the towable rolling terrestrial container to provide a pre-provisioned towable unit comprises pre-positioning the emergency survival items in the plurality of towable rolling terrestrial containers to provide a plurality of pre-provisioned towable units.

20. The method of claim 19 wherein accepting a consideration-based private civil security subscription from a subscriber with respect to providing civilly-catastrophic event-based access to the pre-provisioned towable unit comprises accepting consideration-based private civil security subscriptions from a plurality of subscribers with respect to providing civilly-catastrophic event-based access to corresponding ones of the plurality of pre-provisioned towable units.

21. The method of claim 20 wherein maintaining the pre-provisioned towable unit pending a need to permit subscription-based access to the pre-provisioned towable unit upon occurrence of a catastrophic event comprises maintaining the plurality of pre-provisioned towable units pending a need to permit subscription-based access to the pre-provisioned towable units by authorized beneficiaries of the consideration-based private civil security subscriptions upon occurrence of a catastrophic event.

22. The method of claim 21 wherein maintaining the plurality of pre-provisioned towable units comprises maintaining the plurality of pre-provisioned towable units at a shared predetermined location.

23. The method of claim 22 wherein maintaining the plurality of pre-provisioned towable units at a shared predetermined location comprises maintaining the plurality of pre-provisioned towable units at a shared predetermined location that is substantially secured against unauthorized access.

24. The method of claim 23 further comprising:
providing at least one at least substantially full-time attendant at the predetermined location.

25. The method of claim 24 wherein providing at least one at least substantially full-time attendant at the predetermined location comprises providing an attendant on-site at the predetermined location substantially full-time.

26. The method of claim 25 further comprising:
providing an attendant's quarters on-site at the predetermined location.

27. The method of claim 1 wherein providing a towable rolling terrestrial container comprises providing a towable rolling terrestrial container having living quarters disposed therein.

28. The method of claim 27 wherein providing a towable rolling terrestrial container having living quarters disposed therein comprises providing a towable rolling terrestrial container having disposed therein at least one of:
sleeping accommodations;
food preparation facilities;
personal hygiene facilities;
sitting accommodations.

29. The method of claim 27 wherein pre-positioning the emergency survival items in the towable rolling terrestrial container comprises pre-positioning the emergency survival items in the living quarters.

30. The method of claim 1 wherein providing a towable rolling terrestrial container comprises providing a towable rolling terrestrial container comprising, at least in part, a thermally insulated storage container.

31. The method of claim 30 wherein positioning the emergency survival items in the towable rolling terrestrial container comprises placing at least some emergency survival items that require refrigeration into the thermally insulated storage container.

32. The method of claim 31 wherein maintaining the pre-provisioned towable unit comprises, at least in part, maintaining the emergency survival items that require refrigeration and that are placed in the thermally insulated storage container in a refrigerated state.

33. The method of claim 1 wherein providing a towable rolling terrestrial container comprises providing a towable rolling terrestrial container having at least some spare parts carried therewith.

34. The method of claim 33 wherein the spare parts comprise, at least in part, at least one of:
a spare tire;
a spare fuse;
a spare illumination source.

35. The method of claim 1 wherein providing a towable rolling terrestrial container comprises providing a substantially air-tight towable rolling terrestrial container.

36. The method of claim 34 wherein providing a substantially air-tight towable rolling terrestrial container comprises providing a substantially air-tight towable rolling terrestrial container having a selectable interior positive air pressure capability.

37. The method of claim 1 wherein providing a towable rolling terrestrial container comprises providing a towable rolling terrestrial container having at least one retractable exterior-mounted awning.

38. The method of claim 1 wherein providing a towable rolling terrestrial container comprises providing a towable rolling terrestrial container having water purification apparatus such that the water purification apparatus can be used in a time of emergency to cleanse water and render it potable.

39. The method of claim 1 wherein providing a towable rolling terrestrial container comprises providing a towable rolling terrestrial container having a radio frequency antenna mast such that a two-way wireless communication device can be operably coupled thereto to extend a corresponding effective communications range of the two-way wireless communication device.

40. The method of claim 1 wherein providing a towable rolling terrestrial container comprises providing a towable rolling terrestrial container having at least one user-accessible enclosed secure holding area formed in a wall of the towable rolling terrestrial container.

41. The method of claim 39 wherein providing a towable rolling terrestrial container having at least one user-accessible enclosed secure holding area formed in a wall of the towable rolling terrestrial container comprises a user-accessible enclosed secure holding area that comprises at least one of:
a user-lockable enclosed secure holding area;
a camouflaged user-accessible enclosed secure holding area that is not readily discernable to ordinary observation.
